(19) United States
(12) Patent Application Publication
(10) Pub. No.: US 2019/0194046 A1
(43) Pub. Date: Jun. 27, 2019

(54) SYSTEMS AND METHODS FOR DYNAMIC SANITIZATION CONTROL

(71) Applicant: Hayward Industries, Inc., Elizabeth, NJ (US)

(72) Inventor: Patrick Sweeney, Darnestown, MD (US)

(73) Assignee: Hayward Industries, Inc., Elizabeth, NJ (US)

(21) Appl. No.: 16/230,260

(22) Filed: Dec. 21, 2018

Related U.S. Application Data
(60) Provisional application No. 62/609,609, filed on Dec. 22, 2017.

(51) Int. Cl. C02F 1/72

(52) U.S. Cl. CPC C02F 1/72; C02F 2209/04; C02F 2103/42; C02F 2209/29; C02F 2209/06

(57) ABSTRACT

Systems and methods for dynamic sanitization control are provided. The system determines an ORP minimum set point value and a free chlorine maximum set point value. The system then measures current ORP and free chlorine levels, and determines whether the measured free chlorine is greater than or equal to the free chlorine maximum set point value and whether the measured current ORP level is less than the ORP minimum set point value. The system adjusts chlorine based on free chlorine levels if the measured free chlorine is greater than or equal to the free chlorine maximum set point value and if the measured current ORP level is less than the ORP minimum set point value. Additionally, the system can adjust chlorine based on ORP levels if either (1) the measured free chlorine is less than the free chlorine maximum set point value or (2) the measured current ORP level greater than or equal to the ORP minimum set point value.

### CROSS-REFERENCE TO RELATED APPLICATIONS

This application claims the benefit of U.S. Provisional Patent Application No. 62/609,609 filed on Dec. 22, 2017, the entire disclosure of which is expressly incorporated herein by reference.

### BACKGROUND

### Field of the Disclosure

The present disclosure relates to systems for sanitizing pool and/or spa water, and more specifically, to systems and methods for dynamic sanitization control.

### Related Art

The fundamental understanding of disinfection in aquatic venues has naturally evolved as researchers have become more aware of various factors that impact sanitizer effectiveness. The World Health Organization has long held that ORP (Oxidation Reduction Potential) is the single most important parameter to monitor to ensure that water is microbiologically safe for swimming. In fact, a minimum 650 mV ORP level has been a standard in Europe for decades and is part of most of the health codes there. In the United States, however, there remains a mixed bag of standards, whereby some local health codes rely on the free available chlorine level as the only indicator whereas others have adopted the ORP standards used in Europe.

Unfortunately, there exist situations in which these two approaches are in conflict. For example, it has been observed that some health codes require a minimum ORP of 650 mV, for example, while at the same time, demanding a maximum chlorine level of, for example, 10 ppm. Because ORP and free chlorine are not mutually exclusive properties, it is entirely possible that one parameter can only be satisfied when the other parameter is outside the specified limits. That is to say, health codes that specify both may be over-specifying the system; for any given body of water, there is only one degree of freedom (i.e. free chlorine or ORP) and not two degrees of freedom as the local health code assumes.

Prior art chlorine dispensing systems, however, only control based on one variable. Accordingly, if a prior art chlorine system senses that the ORP level is below a set point, it may continue to release chlorine into the system while the free chlorine level is at the maximum value. The result is that an excess amount of chlorine is released into a swimming pool or spa and bathers can be harmed by excess chlorine. This scenario is not uncommon, as it can be a direct result of complex nature of ORP and how readily it is affected by important water chemistry parameters such as pH, cyanuric acid and TDS.

Therefore, there exists a need for systems and methods for dynamic sanitization control, which addresses the foregoing shortcomings of existing systems.

### SUMMARY

A method for dynamic sanitization control is provided. The method includes the steps of receiving an ORP minimum set point value and a free chlorine maximum set point value, measuring current ORP and free chlorine levels in pool or spa water, determining whether the measured free chlorine is greater than or equal to the free chlorine maximum set point value and whether the measured current ORP level is less than the ORP minimum set point value, and adjusting chlorine based on free chlorine levels if the measured free chlorine is greater than or equal to the free chlorine maximum set point value and if the measured current ORP level is less than the ORP minimum set point value. Additionally, the method includes the steps of adjusting chlorine based on ORP levels if either (1) the measured free chlorine is less than the free chlorine maximum set point value or (2) the measured current ORP level greater than or equal to the ORP minimum set point value.

A controller for dynamic sanitization control is provided. The controller includes a microprocessor and memory having computer instructions stored thereon, which, when executed, cause the controller to perform a number of steps, including receiving an ORP minimum set point value and a free chlorine maximum set point value, measuring current ORP and free chlorine levels, determining whether the measured free chlorine is greater than or equal to the free chlorine maximum set point value and whether the measured current ORP level is less than the ORP minimum set point value, and adjusting chlorine based on free chlorine levels if the measured free chlorine is greater than or equal to the free chlorine maximum set point value and if the measured current ORP level is less than the ORP minimum set point value. Additionally, the instructions cause the controller to adjust chlorine based on ORP levels if either (1) the measured free chlorine is less than the free chlorine maximum set point value or (2) the measured current ORP level greater than or equal to the ORP minimum set point value.

A non-transitory computer-readable medium having computer-readable instructions stored thereon is also provided. When the instructions are executed by a computer system, the instructions cause the computer system to perform a number of steps, including receiving an ORP minimum set point value and a free chlorine maximum set point value, measuring current ORP and free chlorine levels, determining whether the measured free chlorine is greater than or equal to the free chlorine maximum set point value and whether the measured current ORP level is less than the ORP minimum set point value, and adjusting chlorine based on free chlorine levels if the measured free chlorine is greater than or equal to the free chlorine maximum set point value and if the measured current ORP level is less than the ORP minimum set point value. Additionally, the instructions can cause the controller to adjust chlorine based on ORP levels if either (1) the measured free chlorine is less than the free chlorine maximum set point value or (2) the measured current ORP level greater than or equal to the ORP minimum set point value.

### BRIEF DESCRIPTION OF THE DRAWINGS

The foregoing features of the disclosure will be apparent from the following Detailed Description, taken in connection with the accompanying drawings, in which:

FIG. 1 is a diagram illustrating the system of the present disclosure;

FIG. 2 is a flowchart illustrating processing steps carried out by the system for dynamic sanitization control; and

FIG. 3 is a diagram showing hardware and software components of a computer system on which the system of the present disclosure could be implemented.

### DETAILED DESCRIPTION

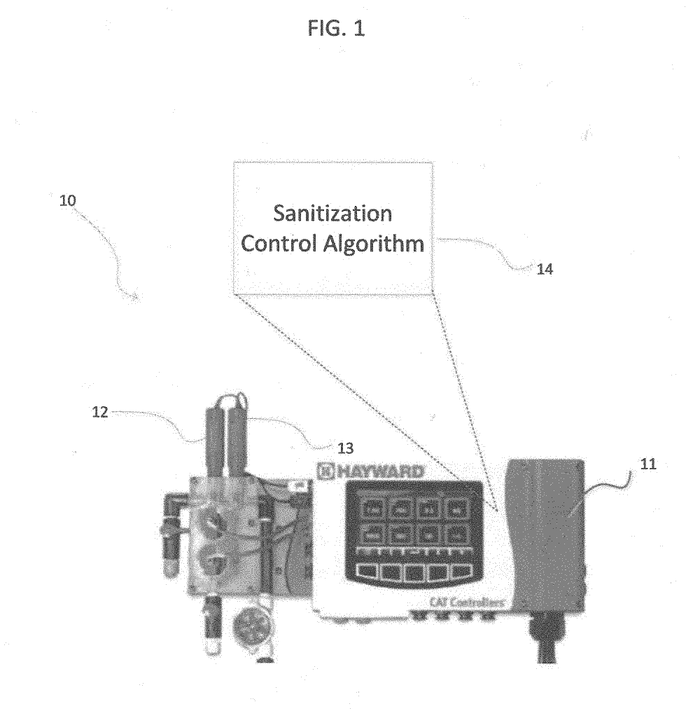

The present disclosure relates to systems and methods for dynamic sanitization control, as discussed in detail below in connection with FIGS. 1-3.

FIG. 1 is a diagram illustrating a sanitization system 10 of the present disclosure. The system 10 includes a controller 11 for electronically controlling operation of the sanitization system 10, as will be discussed in greater detail below. The controller 11 can include a display/touchscreen to provide readouts of any of the values relating to chlorine dispensing and the variables as will be discussed in greater detail below, and to allow a user to control operation of the system 10. The system 10 can electronically control a chlorine generator and/or dispenser to chlorinate a body of water such as a swimming pool or a spa. The system 10 can include a microprocessor, a memory, a transceiver, a solid state drive, and a plurality of sensors. In particular, the system 10 can include an oxidation-reduction potential (ORP) sensor 12 for determining the level of ORP in a body of water. The system 10 can also include a free chlorine sensor 13 for determining the level of free chlorine in a body of water.

The microprocessor and/or memory can have computer instructions stored thereon for implementing and executing a sanitization control algorithm 14 for controlling the amount of chlorine dispensed into a swimming pool or spa. Optionally, the transceiver can allow the system 10 to wirelessly communicate with a remote computer system which can include a personal computer, tablet, mobile device or a server. The system 10 can have WiFi, Bluetooth, 3G, 4G, LTE, and other similar wireless capabilities which can allow a mobile device such as a smartphone or a tablet to control the chlorine dispenser. The remote computer system can allow the system 10 to receive software updates or the remote computer system can control the system 10 remotely. The system 10 can include the ORP sensor 12, the free chlorine sensor 13, the touchscreen 11, and the sanitization control algorithm 14 on a chlorinator or any other type of device associated with a pool or spa environment, such as the OMNILOGIC pool/spa system controller.

The controller 11 can include the logic to make the chlorine feed decisions. In particular, the controller 11 can implement fixed- or time-based proportional chlorine feed by activating relays to turn chlorine pumps, generators, or solenoid valves on or off as needed. In some embodiments, the chlorine feeder itself may not have any logic and can receive its instructions from the controller 11. Even further, the sanitization control algorithm 14 need not be located within the controller 11, and indeed, could be stored on and executed by a computer system remote from the controller 11 and in communication therewith, such that the controller 11 could be remotely controlled by such remote computer systems.

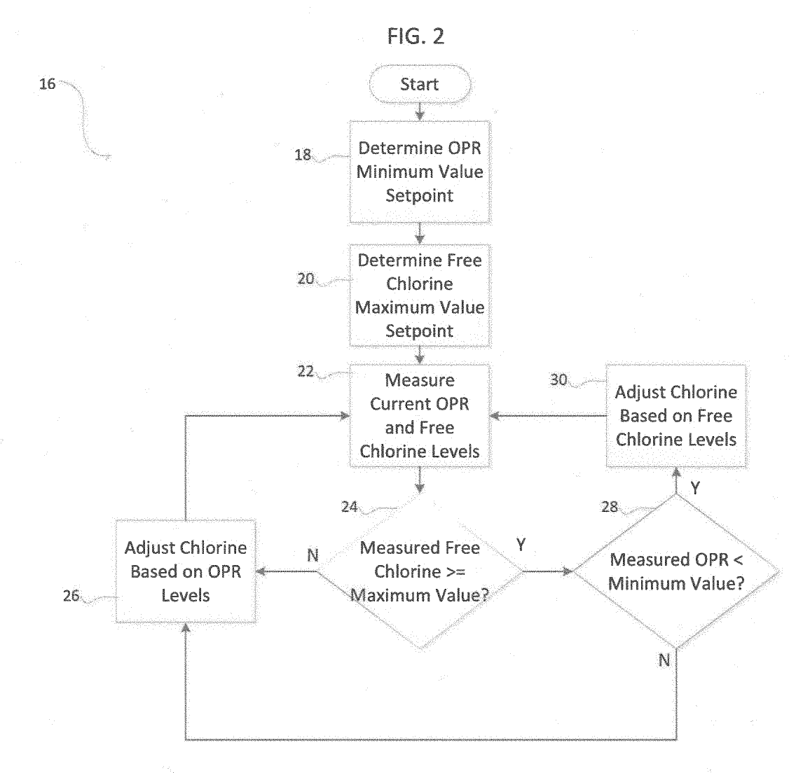

FIG. 2 is a flowchart illustrating processing steps 16 carried out by the system for dynamic sanitization control. In step 18, the system determines an ORP minimum set point value. In step 20, the system determines a free chlorine maximum set point value. In step 22, the system measures a current ORP level and a free chlorine level. The chlorine dispenser 10 can perform such measurement using at least one of the plurality of sensors. In step 24, the system determines whether the measured free chlorine level is greater than or equal to the maximum free chlorine set point value received in step 20. If a negative determination is made, the process 16 proceeds to step 26 where the chlorine can be adjusted based on the ORP minimum set point value received in step 18 and the measured ORP level. The chlorine dispenser 10 can adjust the amount of chlorine being released into the swimming pool or spa based on ORP minimum set point value. If a positive determination is made in step 24, the process 16 proceeds to step 28 where the system determines whether the measured ORP level is less than the ORP minimum set point value received in step 18. If a negative determination is made in step 28, the process 16 can proceed to step 26 where the chlorine can be adjusted based on the ORP minimum set point value received in step 18 and the measured ORP level. Adjusting based on the ORP level in this case is appropriate because the ORP level is greater than the set point minimum, and therefore the sanitization control algorithm 14 will not provide an instruction for the chlorine dispenser 10 to release more chlorine in the body of water, thereby preventing the free chlorine level in the pool from increasing further beyond the maximum set point value received in step 20.

If a positive determination is made in step 28, adjusting based on measured ORP levels can be problematic because the sanitization control algorithm 14 will provide an instruction to the chlorine dispenser 10 to release more chlorine while the measured free chlorine is already greater than or equal to the set point maximum free chlorine value received in step 20. Therefore, when a positive determination is made in step 28, the process 16 proceeds to step 30 and dynamically switches control to adjusting chlorine output based on the free chlorine set point maximum value received in step 20 and the measured free chlorine levels. This ensures that the sanitization control algorithm 14 will not provide an instruction for the system 10 to release more chlorine in the body of water while the measured free chlorine is already greater than or equal to the set point maximum free chlorine value received in step 20. The dynamic control between ORP and free chlorine can prevent excess chlorine from being released into a body of water, which can prevent harmful effects to bathers.

An example in connection with the processing steps 16 will now be described in greater detail. For example, assume that a local health code requires a minimum ORP level of 650 mV and a maximum chlorine level of 5 ppm on an aquatic venue. The processing steps 16 can control the chlorine feed system to maintain the ORP of the water at 650 mV. However, if the chlorine level reaches 5 ppm and the ORP drops below 650 mV, the processing steps 16 will adjust the chlorine feed system to control based on the maximum chlorine level (e.g., in step 30). Accordingly the processing steps 16 can control the level of chlorine based on ORP level as long as possible and then override that control when the above condition is met (e.g., step 28). Accordingly, the processing steps 16 can default to control the level of chlorine based on ORP levels which can be an effective measurement for the sanitizer. Toward this end, a 650 mV minimum can be maintained or any other value can be maintained within the scope of the present disclosure. However, once the free chlorine level reaches the maximum limit of the local regulation in force and the ORP level is below the set point, the processing steps 16 can dynamically switch to control the level of chlorine based on the free chlorine as was discussed in greater detail above.

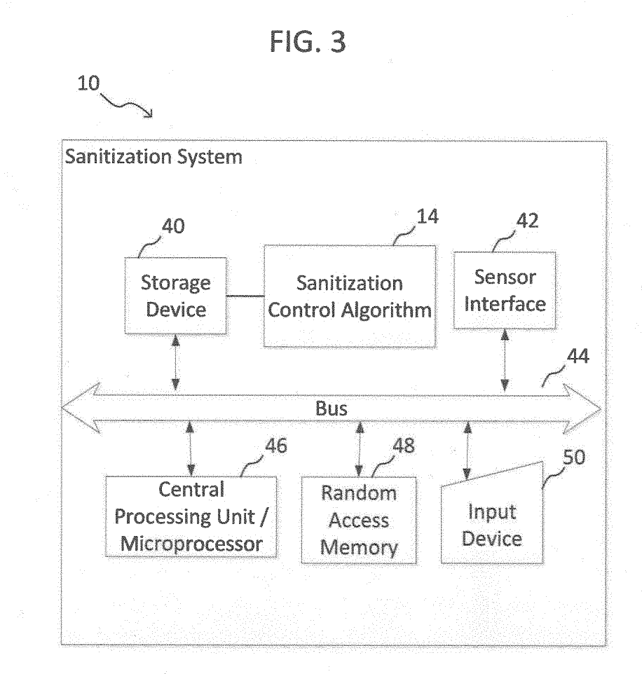

FIG. 3 is a diagram showing hardware and software components of the sanitization system 10 The system 10 includes a storage device 40 (which could include any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.)). The sanitization control algorithm 14 is stored in the storage device 40, and could be embodied as computer-readable program code stored on the storage device 40 and executed by the central processing unit (CPU)/microprocessor 48 using any suitable, high or low level computing language, such as Python, Java, C, C++, C#, .NET, MATLAB, etc. The sensor interface 42 interfaces with one or more sensors of the system 10, such as the sensors 12 and 13 of FIG. 1. Additionally, the system 10 could include an Ethernet network interface device, a wireless network interface device, or any other suitable device which permits the system 10 to communicate a remote device over a network connection, such as the Internet. The CPU 46 could include any suitable single- or multiple-core microprocessor of any suitable architecture that is capable of implementing and running the sanitization control algorithm 14. The random access memory 48 could include any suitable, high-speed, random access memory typical of most modern computers, such as dynamic RAM (DRAM), etc. The input device 50 could include, but is not limited to, the touchscreen discussed above in connection with FIG. 1, display, keyboard, mouse, etc.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is intended to be protected by Letters Patent is set forth in the following claims.

What is claimed is:

1. A method for dynamic sanitization control, comprising:
determining an Oxidation Reduction Potential (“ORP”) minimum set point value for a body of water;
determining a free chlorine maximum set point value for the body of water;
measuring an ORP level and a free chlorine level of the body of water;
determining whether the measured free chlorine level is greater than or equal to the free chlorine maximum set point value;
when the measured free chlorine level is greater than or equal to the free chlorine maximum set point value, determining whether the measured ORP level is less than the ORP minimum set point value; and
adjusting chlorine based on the free chlorine level when the measured ORP level is less than the ORP minimum set point value.

2. The method of claim 1, further comprising adjusting chlorine based on the ORP level when either (1) the measured free chlorine level is less than the free chlorine maximum set point value or (2) the measured ORP level is greater than or equal to the ORP minimum set point value.

3. The method of claim 1, wherein the ORP level is measured by an ORP sensor and the free chlorine level is measured by a free chlorine sensor.

4. The method of claim 1, further comprising performing step of measuring the ORP level and the free chlorine level after performing step of adjusting chlorine based on the ORP level or step of adjusting chlorine based on free chlorine level.

5. The method of claim 1, wherein the ORP minimum set point value is 650 mV.

6. The method of claim 1, wherein the free chlorine maximum set point value is 5 ppm or 10 ppm.

7. A system for dynamic sanitization control, comprising:
a non-transitory computer-readable medium storing computer executable instruction for a process of dynamically controlling sanitization;
a processing device programmed to execute the computer executable instructions to:
determine an Oxidation Reduction Potential (“ORP”) minimum set point value for a body of water;
determine a free chlorine maximum set point value for the body of water;
measure an ORP level and a free chlorine level of the body of water;
determine whether the measured free chlorine is greater than or equal to the free chlorine maximum set point value;
when the measured free chlorine is greater than or equal to the free chlorine maximum set point value, determine whether the measured ORP level is less than the ORP minimum set point value;
adjust chlorine based on free chlorine levels when the measured ORP level is less than the ORP minimum set point value.

8. The system of claim 7, wherein the processing device is programmed to execute the computer executable instructions to adjust chlorine based on the ORP level when either (1) the measured free chlorine is less than the free chlorine maximum set point value or (2) the measured ORP level is greater than or equal to the ORP minimum set point value.

9. The system of claim 7, wherein the ORP level is measured by an ORP sensor and the free chlorine levels are measured by a free chlorine sensor.

10. The system of claim 7, wherein the processing device is programmed to execute the computer executable instructions to perform step of measuring the ORP level and the free chlorine level after performing step of adjusting chlorine based on the ORP level or step of adjusting chlorine based on free chlorine level.

11. The system of claim 7, wherein the ORP minimum set point value is 650 mV.

12. The system of claim 7, wherein the free chlorine maximum set point value is 5 ppm or 10 ppm.

13. The system of claim 7, further comprising a display to provide readouts of the ORP level and the free chlorine level.

14. A non-transitory computer readable medium comprising instructions for causing a computer to perform steps of:
determining an Oxidation Reduction Potential (“ORP”) minimum set point value for a body of water;
determining a free chlorine maximum set point value for the body of water;
measuring an ORP level and a free chlorine level of the body of water;
determining whether the measured free chlorine level is greater than or equal to the free chlorine maximum set point value;
when the measured free chlorine level is greater than or equal to the free chlorine maximum set point value, determining whether the measured ORP level is less than the ORP minimum set point value; and
adjusting chlorine based on the free chlorine level when the measured ORP level is less than the ORP minimum set point value.

15. The non-transitory computer readable medium of claim 14, further comprising instructions for causing the computer to perform steps of adjusting chlorine based on the ORP level when either (1) the measured free chlorine level is less than the free chlorine maximum set point value or (2) the measured ORP level is greater than or equal to the ORP minimum set point value.

16. The non-transitory computer readable medium of claim 14, wherein the ORP level is measured by an ORP sensor and the free chlorine level is measured by a free chlorine sensor.

17. The non-transitory computer readable medium of claim 14, further comprising performing step of measuring the ORP level and the free chlorine level after performing step of adjusting chlorine based on the ORP level or step of adjusting chlorine based on free chlorine level.

18. The non-transitory computer readable medium of claim 14, wherein the ORP minimum set point value is 650 mV.

19. The non-transitory computer readable medium of claim 14, wherein the free chlorine maximum set point value is 5 ppm or 10 ppm.
